(19) United States
(12) Patent Application Publication
(10) Pub. No.: US 2012/0091694 A1
(43) Pub. Date: Apr. 19, 2012

(54) HAND CART FOR VEHICLE

(75) Inventor: Seung Kwon Cha, Yongin-si (KR)

(73) Assignee: Hyundai Motor Company, Seoul (KR)

(21) Appl. No.: 13/010,634

(22) Filed: Jan. 20, 2011

(30) Foreign Application Priority Data
Oct. 19, 2010 (KR) 10-2010-0101852

(51) Int. Cl. B62B 1/04; B62B 1/00

(52) U.S. Cl. 280/651; 280/47.34; 280/47.371

(57) ABSTRACT

A hand cart for a vehicle is provided, which includes a cart which is provided in a luggage board of the vehicle and has wheels mounted on a bottom surface of the cart, and a handle rotatably mounted on one side of the cart. The cart, which is in the form of a movable tray, is provided in a trunk of the vehicle to improve the productivity.

### CROSS-REFERENCE TO RELATED APPLICATION

The present application claims priority to Korean Patent Application No. 10-2010-0101852, filed on Oct. 19, 2010 in the Korean Intellectual Property Office, the entire contents of which is incorporated herein for all purposes by this reference.

### BACKGROUND OF THE INVENTION

1. Field of the Invention

The present invention relates to a hand cart for a vehicle, and more particularly, to a hand cart for a vehicle, which can provides a cart in the form of a movable tray in a luggage board having a multi-purpose tray structure.

2. Description of the Prior Art

In general, behind a rear seat of a Wagon vehicle or sport-utility and multi-purpose vehicle recently popularized, luggage space for accommodating various kinds of luggage is provided.

In such luggage space, various kinds of packs can be accommodated. In particular, since the luggage space is located in vehicle indoor space that passengers gets in, a passenger can take luggage in or out of the luggage space even during running of the vehicle to provide great convenience for the passenger.

On the other hand, if the size of luggage to be loaded is large, as illustrated in FIG. 1, it may be possible to secure larger luggage space by completely folding a backrest of a rear seat in a forward direction.

FIG. 1 is a view illustrating an indoor space of a vehicle in the related art.

As illustrated in FIG. 1, luggage space 13 is provided behind a rear seat 15 of a vehicle 4. This luggage space 13 is space between a backrest 15a of the rear seat 15 and a tail door (hatchback door), and has a width between mutually opposite side trims 19.

The side trims 19 form both side walls of the luggage space, and is inwardly curved so that a tire can be positioned on the outside thereof.

Also, the backrest 15a of the rear seat 15 can be completely folded in a forward direction to be in contact with a seat 15b.

As described above, by completely folding the backrest 15a in the forward direction, the luggage space can be extended.

On the other hand, a hinge device 21 rotatably supports the backrest 15a in forward/backward directions against the seat 15b. A torsion spring or ratchet is provided in the hinge device 21 to maintain the backrest 15a at a desired angle against the seat 15b.

However, the luggage space is fixedly provided in the related art, it is not possible to move it.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a hand cart for a vehicle, which can provides a cart in the form of a movable tray in a luggage board having a multi-purpose tray structure.

In one aspect of the present invention, the hand cart apparatus for a vehicle, may include a cart which may be configured and dimensioned to be provided in a luggage board of the vehicle and may have wheels mounted on a bottom surface of the cart, and a handle rotatably mounted on a side of the cart.

A hook may be provided on a side of the handle, and the cart may be fixed using the hook in a state where the cart and a foldable tray mounted to the cart may be mounted on the luggage board.

The cart may be shaped of a tetragonal panel, and a foldable tray may be mounted on an upper end surface of the cart.

The handle may have a telescopic multistage structure.

A rotating angle of the handle may be limited to about 120 degree against the bottom surface of the cart.

The wheels may be foldably mounted on the cart through a hinge connector.

A width of the foldable tray may be smaller than a space between handles.

With the above-described construction according to the present invention, a cart in the form of a movable tray is provided in a trunk of the vehicle, and thus the productivity can be improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating an indoor space of a vehicle in the related art.

FIG. 2 is a view illustrating the state where a hand cart for a vehicle according to an exemplary embodiment of the present invention is mounted on a luggage board.

FIG. 3 is a view illustrating a hand cart for a vehicle according to an exemplary embodiment of the present invention.

FIG. 4A is a view illustrating an upper portion of a hand cart for a vehicle in a state where a handle is folded according to an exemplary embodiment of the present invention.

FIG. 4B a view illustrating a bottom portion of a hand cart for a vehicle in a state where a handle is folded according to an exemplary embodiment of the present invention.

FIG. 5A is a view illustrating a state where a tray is folded in a hand cart for a vehicle according to an exemplary embodiment of the present invention.

FIG. 5B is a view illustrating a state where a tray is unfolded in a hand cart for a vehicle according to an exemplary embodiment of the present invention.

FIG. 6 is a view illustrating a hook in a hand cart for a vehicle according to an exemplary embodiment of the present invention.

FIG. 7 is a view illustrating wheels connected to a hinge connector in a hand cart for a vehicle according to an exemplary embodiment of the present invention.

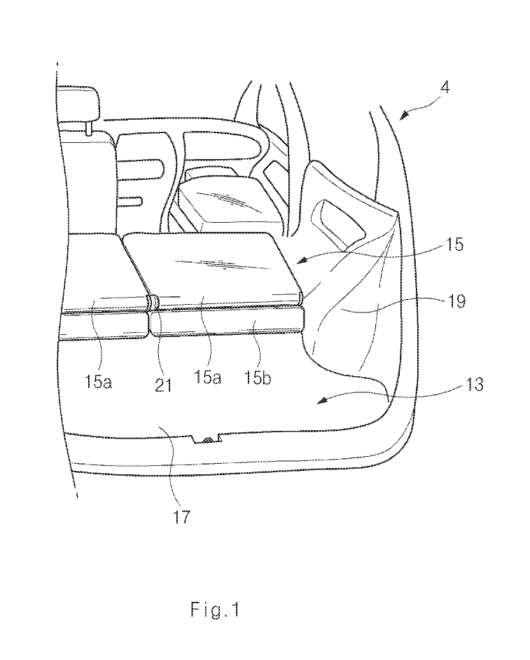

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

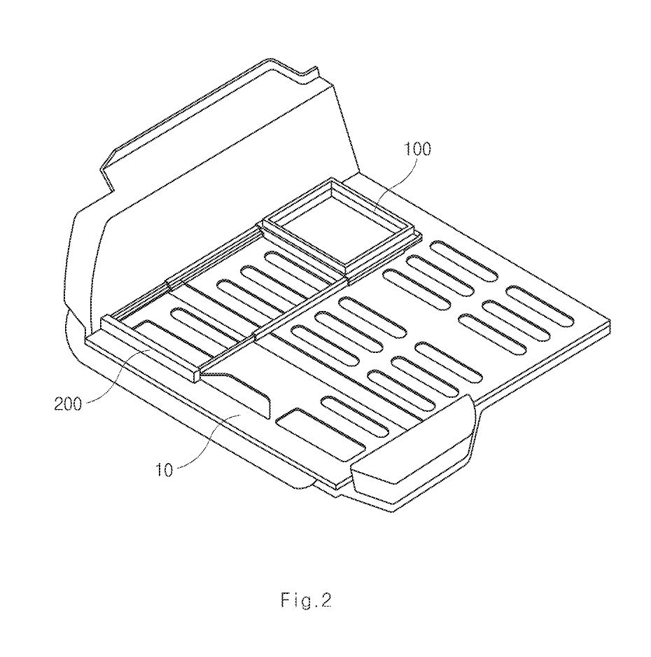

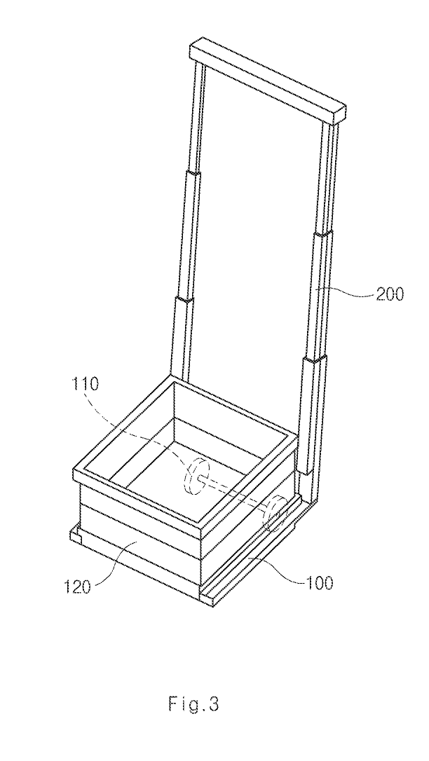

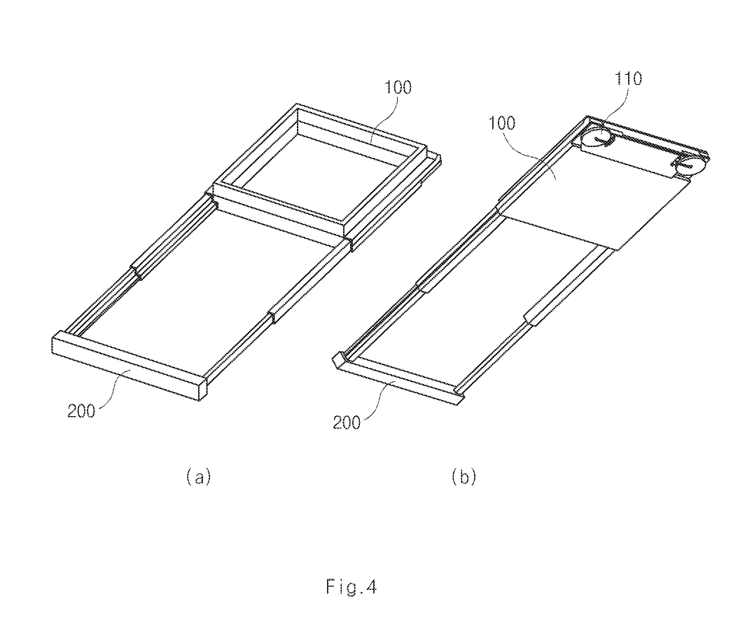

FIGS. 2 to 7 are views illustrating a hand cart for a vehicle according to an exemplary embodiment of the present invention. FIG. 2 is a view illustrating the state where a hand cart for a vehicle according to an exemplary embodiment of the present invention is mounted on a luggage board, FIG. 3 is a view illustrating a hand cart for a vehicle according to an exemplary embodiment of the present invention, and FIG. 4 are views illustrating an upper portion and a bottom portion of a hand cart for a vehicle in a state where a handle is folded according to an exemplary embodiment of the present invention.

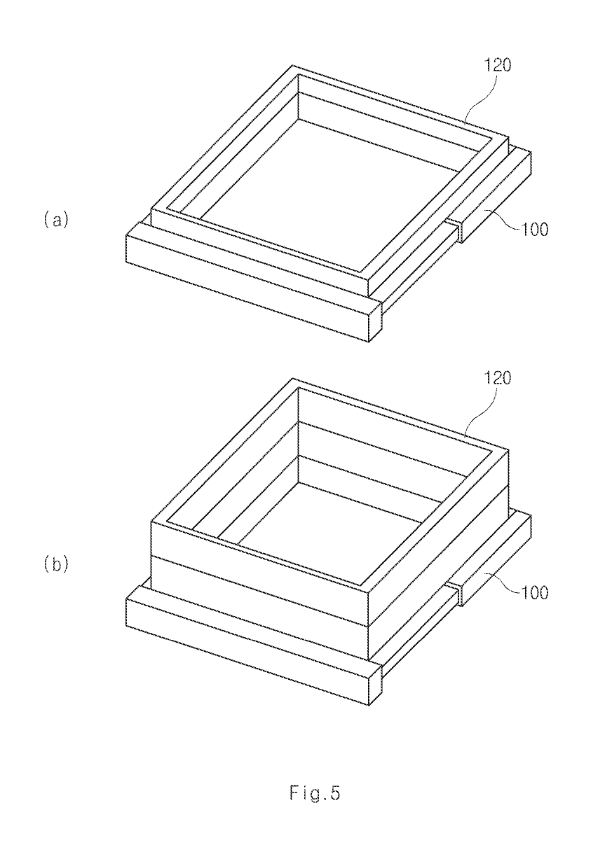

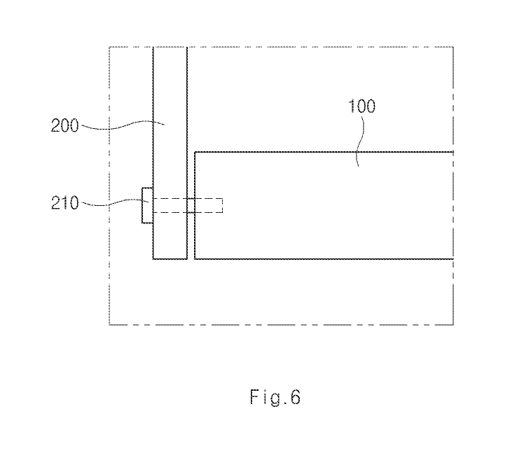

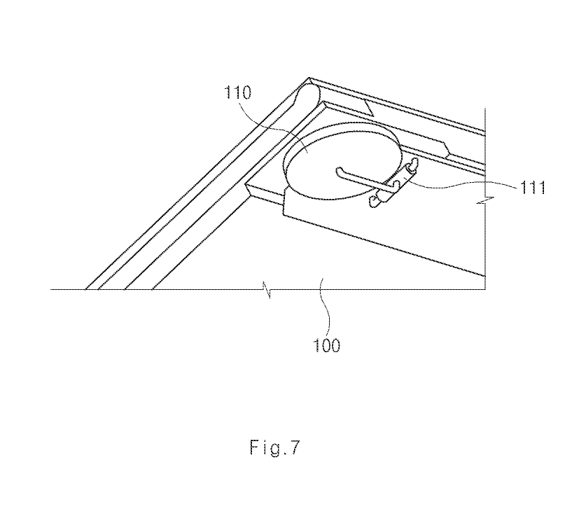

FIG. 5 are views illustrating the states where a tray is folded and unfolded in a hand cart for a vehicle according to an exemplary embodiment of the present invention, FIG. 6 is a view illustrating a hook in a hand cart for a vehicle according to an exemplary embodiment of the present invention, and FIG. 7 is a view illustrating wheels connected to a hinge connector in a hand cart for a vehicle according to an exemplary embodiment of the present invention.

A hand cart for a vehicle according to an exemplary embodiment of the present invention, as illustrated in FIGS. 2 to 7, has the basic technical features in that a handle 200 is rotatably mounted on one side of a cart 100 having wheels 110 mounted on the bottom surface of the cart. Accordingly, a movable cart is provided to improve the productivity.

Hereinafter, respective constituent elements of the hand cart for a vehicle according to an exemplary embodiment of the present invention will be described in detail with reference to the accompanying drawing.

As illustrated in FIG. 2, the hand cart is basically provided in a luggage board 10 that is provided behind a rear seat or in a trunk of the vehicle.

As illustrated in FIGS. 3 and 4, the cart 100 has the wheels 110 mounted on the bottom surface of the cart so that the cart is movable.

As illustrated in FIG. 5, the cart 100 is in the form of a tetragonal panel, and a foldable tray 120 is additionally mounted on the upper end surface of the cart 100 to facilitate the safekeeping of the cart in the luggage board 10.

The handle 200 is rotatably mounted on one side of the cart 100. When the cart 100 is not in use, it is kept in the luggage board 10 as illustrated in FIGS. 2 and 4, and when the cart 100 is in use, it is unfolded to be used as illustrated in FIG. 3.

As illustrated in FIG. 3, it is preferable that the handle 200 is formed to be long enough for a user to pull the cart 100 even without bending the body in a state where the user stands up. In order to use the cart 100 conveniently in consideration of the user's height, the handle 200 may have a telescopic multistage structure that enables the adjustment of the length of the handle 200.

On the other hand, the rotating angle of the handle 200 is limited to, for example, 120° against the bottom surface of the cart 100, and thus the handle 200 is prevented from being further lowered so that the user has difficulty in holding the handle 200.

Also, in association with the rotating angle of the handle 200, as illustrated in FIG. 6, a hook 210 is provided on one side of the handle 200, and thus the user can fix the cart to a side trim using the hook 210, so that a holder type fixing structure is maintained, in a state where the cart 100 and the foldable tray 120 are put on the luggage board 10.

As illustrated in FIG. 7, the wheels are mounted on the bottom surface of the cart 100 through a hinge connector 111, and when the hinge connector 111 is rotated, the wheels 110 also become rotatable. Accordingly, when the cart 100 is not in use, the wheels 110 are rotated and folded toward the bottom surface, while when the cart 100 is in use, the wheels 110 are rotated in the opposite direction to be in a movable state.

Hereinafter, the operation and effect of the cart 100 according to an exemplary embodiment of the present invention will be described.

As illustrated in FIG. 3, the handle 200 is rotatably mounted on one side of the cart 100 having the wheels 110 mounted on the bottom surface of the cart 100. When the cart 100 is not in use, it is put on the luggage board 10 provided behind the rear seat or in the trunk of the vehicle, and when the cart 100 is in use, the user can easily move the cart 100 using the handle 200 and the wheels 110 of the cart 100.

On the upper end surface of the cart 100, the foldable tray 120 is additionally mounted, and the wheels 110 are mounted on the bottom surface of the cart 100 through the hinge connector 111. When the hinge connector 111 is rotated, the wheels 110 become also rotatable. Accordingly, when the cart 100 is not in use, as shown in FIG. 4, the tray 120 is folded, and the wheels 110 are rotated toward the bottom surface of the cart 100 so that the cart 100 is in a folded state. When the cart 100 is in use, as shown in FIG. 5, the tray 120 is unfolded, and the wheels 110 are rotated toward the ground so that the cart 100 is in a movable state.

The handle 200 is rotatably mounted on one side of the cart 100. When the cart 100 is not in use, it is kept in the luggage board as illustrated in FIGS. 2 and 4, and when the cart 100 is in use, it is unfolded to be used as illustrated in FIG. 3. In order to use the cart 100 conveniently in consideration of the user's height, the handle 200 may have a telescopic multistage structure that enables the adjustment of the length of the handle 200.

According to the hand cart for a vehicle as constructed above according to an exemplary embodiment of the present invention, the handle is rotatably mounted on one side of the cart having the wheels mounted on the bottom surface of the cart, and thus the movable cart in form of a tray is provided in the vehicle trunk to improve the productivity.

Although preferred embodiments of the present invention have been described for illustrative purposes, those skilled in the art will appreciate that various modifications, additions and substitutions are possible, without departing from the scope and spirit of the invention as disclosed in the accompanying claims.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hand cart apparatus for a vehicle, comprising:
a cart which is configured and dimensioned to be provided in a luggage board of the vehicle and has wheels mounted on a bottom surface of the cart; and
a handle rotatably mounted on a side of the cart.

2. The hand cart apparatus according to claim 1, wherein a hook is provided on a side of the handle, and the cart is fixed using the hook in a state where the cart and a foldable tray mounted to the cart are mounted on the luggage board.

3. The hand cart apparatus according to claim 1, wherein the cart is shaped of a tetragonal panel, and a foldable tray is mounted on an upper end surface of the cart.

4. The hand cart apparatus according to claim 3, wherein a hook is provided on a side of the handle, and the cart is fixed using the hook in a state where the cart and the foldable tray are mounted on the luggage board.

5. The hand cart apparatus according to claim 1, wherein the handle has a telescopic multistage structure.

6. The hand cart apparatus according to claim 1, wherein a rotating angle of the handle is limited to about 120 degree against the bottom surface of the cart.

7. The hand cart apparatus according to claim 1, wherein the wheels are foldably mounted on the cart through a hinge connector.

8. The hand cart apparatus according to claim 1, wherein a width of the foldable tray is smaller than a space between handles.
